(19) United States
(12) Patent Application Publication
(10) Pub. No.: US 2001/0014895 A1
(43) Pub. Date: Aug. 16, 2001

(54) METHOD AND APPARATUS FOR DYNAMIC SOFTWARE CUSTOMIZATION

(76) Inventor: NAMEETA SAPPAL, HONOLULU, HI (US)

Correspondence Address: DUKE W YEE, P O BOX 802334, DALLAS, TX, 75380

(21) Appl. No.: 09/054,848

(22) Filed: Apr. 3, 1998

(51) Int. Cl. G06F 15/00

(52) U.S. Cl. 707/500

(57) ABSTRACT

A method and apparatus are provided for presenting customized information content. The method involves accepting as input a personal attribute of a human user and displaying information which is customized based upon the personal attribute. For example, an electronic document containing a set of hyperlinks may be delivered using “he” gender references if the user is a male, and “she” gender references if the user is a female. Similarly, an electronic document may be tailored to present examples and media which best relate to a user. For example, in an electronic educational materials, different sets examples and images may be presented depending on the user's gender, race, culture, and age. Inventive systems are provided to implement the invention in stand-alone computers, web browsers, and web servers.

### BACKGROUND OF THE INVENTION

1. Field of the Invention

The present invention relates generally to an improved data processing system and in particular to a display of graphical and textual information on a data processing system. Still more particularly, the invention relates to an automatic customization of displayed information content based upon specified attributes of a human user.

2. Description of the Related Art

Ergonomics or human engineering is an engineering discipline that involves the optimization of man-machine interfaces. Ergonomic designs attempt to optimize systems for ease of use and other aspects relating to human sensation and preference. In computer technology, the principal user interface involves a monitor, keyboard, and mouse. From a hardware perspective, the monitor should be pleasing to the eye, and the keyboard and mouse should feel pleasing to touch. From a software perspective, the window and menu systems should be logical, easy to navigate, and easy to remember. In prior art systems, the problem of authoring information content and designing a user interface have been considered as separate problems. In modern systems involving electronically published materials, information content authoring and user interface design are beginning to merge. There remains a need to provide improved methods and systems to deliver ergonomically customized information content to an individual user.

Information delivery has recently undergone significant change. For the first time since the advent of the printing press, electronic publishing offers a medium whereby a user can interact with a document. Multimedia technology further allows interactive documents to be constructed which incorporate text, audio, still images, animation and video. Moreover, interactive documents may incorporate computer programs, which perform logical operations such as data base searches to help the user interact with the document. Standalone multimedia applications written in C, C++ or Director are often distributed on CD-ROM or floppy disks. These multimedia applications often provide sound and graphics as part of an interactive document and may include for example, a book or training program.

Additionally, another technology for interactive document design and implementation is known as hypertext markup language (HTML). For a thorough treatment of the HTML language, see T. Savola, A. Westenboek, and J. Heck, USING HTML, Que publishing, 1995. In HTML, an interactive document may be constructed through the use of computer language constructs incorporating the use of tags and identifiers. For example, <par> . . . </par> indicates to an HTML display processor to display any text between the tags as a plain- text paragraph. Other HTML tags may be used to identify images, audio segments, video clips, and the like. Reference tags are used to associate text segments or other displayed objects with addresses. IN HTML, a reference tag has the form HREF=“link_address” where link_address is an address to associated information. When a reference tag containing an address is co-located with an object between a set of HTML tags, the enclosed object becomes a so-called hyperlink to the referenced address specified by the HREF tag. When the user positions a cursor above the hyperlink and clicks with a mouse button, information referenced by the HREF address will be displayed.

HTML documents may be used for a variety of purposes. One type of HTML document is a self-contained interactive document delivered on a CD-ROM. For example, the CD-ROM may contain an interactive training program, a multimedia encyclopedia, or documentation for a computer operating system. The interactive document will often be embodied as an HTML document containing hyperlinks to text, audio, images, and video. The HTML document may also contain a search engine to help navigate and find information within the document.

HTML is the standard language used to construct Internet web pages. The hypertext transport protocol (HTTP) is used to send HTML documents between application programs linked through TCP/IP (transmission control protocol/Internet protocol) connections. An application program, which formats and presents HTML documents for viewing on a display monitor is known as a web browser. A web browser also exchanges information across the Internet using the HTTP application layer protocol. A web browser typically interacts with an application program known as a socket. The socket typically interfaces to a dialer program and a process which implements a TCP/IP protocol stack. The socket is supplied by the operating system of the local machine hosting the browser. In terms of the client-server model, a browser is a client program, which connects to a web server via an HTTP connection, which is implemented as the application layer over a TCP/IP network. A web server is a computer, which delivers information in the form of HTTP packets in response to client requests. A web server typically involves one or more computers, mass storage devices, one or more TCP/IP connections, software capable of responding to client requests. In general, web servers may be constructed using different protocols, but the HTTP application layer protocol and the TCP/IP network protocols are currently the most commonly used internet protocols. In general, the Internet is a set of connections and protocols that allow information to be transferred between different computer networks.

A web site is a software system used to provide information content from a web server. The web site includes all information content and related software programs used to deliver the information content in response to client HTTP requests. For example, a web site includes all information delivered by a web server to include advertisement and information services.

A known problem in writing style and information presentation style as employed in published information content regards the use of gender, race, and other personal attributes. For centuries it has been the stylistic norm to use the word “he” to mean “anyone”, i.e., “he” and “she.” In a given article discussing how to perform a task, the gender reference “he” may be used over and over while in fact, the reference applies equally well to women. In recent years it has been recognized that women readers may not relate as well to published material that generically uses male gender references. Since more and more women have entered the workplace, articles that were targeted mainly to male readers now should be targeted to both male and female readers. A common solution to this problem is to alter the discussion and examples to use “she” instead of “he.” This approach is reactionary and simply alters the problem so that the male readers may not relate well to the article. A compromise approach is to alter the examples and discussion so that roughly half of the gender references are “he”, and the others are “she.” This, however, can be distracting to the reader and it can be argued that the reader may not relate well to half of the information. Yet another approach is to avoid the use of gender references all together. The words “he” and “she” can be replaced by “one,” for example. While this avoids the problem, it is more sterile and has attendant problems with the user not relating to the material, especially when the material describes human activity.

For example with educational materials, educators have recognized the need to present material with examples that are relevant to the student. Studies show that science and math textbooks have long been discouraging for girls because a great majority of their examples and pictures are centered on male characters, making it hard for girls to relate to. Studies also show that textbooks may get their point across better by presenting culturally relevant material and examples. The use of other human attributes in the presentation of published information content presents similar problems. A problem arises since the textbooks must be designed to reach a broad audience. For example, culturally directed examples targeted to inner-city high school students may be irrelevant and distracting to a student in a rural farming community. In the prior art, compromises are necessary due to the economy of producing one book or one set of training materials for a broad and diverse population.

It would be desirable to have an information delivery technology that could reach a broad and diverse reader population without the attendant difficulties with the prior art. It would be desirable if the technology could be implemented economically so one document could be produced to meet the needs of audiences of diverse cultures and genders. It also would be desirable to have a technology whereby a single standalone multimedia program can be customized on the fly to cater to the user.

It would be desirable to have a technology whereby a single interactive electronic document could be stored in a central location and accessed by many viewers across a network such as the Internet. It would further be desirable if this single document could be customized to supply examples and gender references for a diverse user population. It would also be desirable if web browsers could be configured to filter Internet information so that certain text segments could be modified to be matched to the personal attributes of an individual user.

### SUMMARY OF THE INVENTION

The present invention solves these and other problems by providing methods and apparatus to customize the information content delivered by an interactive electronic document in accordance with one or more personal attribute parameters supplied by a user. A personal attribute may be any human quality of the user, for example, gender, race, or age. The interactive document may prompt the user for one or more personal attributes and then tailor the presentation to relate best to the individual. The invention provides a flexible ergonomic user interface within the information content itself. If the user is a female, examples in the presentation may use female characters and gender references may be made to “she.” If the user is a male, the examples may use male characters and gender references may be made to “he”, where appropriate.

The invention solves the prior art problems of high cost solutions by replacing the need to produce multiple copies of a textbook or sets of training materials for multiple audiences by the ability to produce single program or a single electronic document that may be customized to meet the preferences of the individual user. A single distribution medium may deliver plural sets of content or a single modifiable set of content to the user.

The present invention solves the prior problem of being offensive to users of a certain gender, culture, or age group. Previously, the authors of documents and programs were forced to select a particular group to cater to and use language and pictures that appealed to that audience. For example, if the writers of a science program or article determined that their user base was 65% male and 35% females, then they would select to use male characters, pictures, and text throughout their presentation. Their choice was to not appeal to 35% of the users who are females. But prior to the present invention creators or writers were satisfied because they were catering to the majority of their audience. Alternatively, prior to the present invention, creators were forced to script their information for a very broad audience often times watering down the information or losing the impact of the article or program. Wherever a gender specific term is required, the creators would use both genders so as not to offend the user. For example, the creators would use “he or she” throughout the article instead of selecting and using only “he” or only “she” throughout.

An interactive document may prompt the user to enter a set of personal information, and the presentation may be tailored to the individual through the use of conditional statements or standard replacement variables within the document. Different variable sets may be used whose values may evaluate to gender or culture-specific words in the course of translating the HTML code for display on a monitor. In accordance with the present invention a new type of tagged expression “<tvar> gender <\tvar>” may be added to HTML document. When this type of expression is encountered by a browser designed in accordance with the present invention, the browser may replace instances of the gender-variable with the strings “he” or “she”, for example, for display. In this case the gender-variable is an environment variable, which evaluates to “he” or “she”, depending on an attribute entered by the user. Hence with the invention, the user is able to assimilate the information content of the electronic document without being distracted by the use of misdirected gender or cultural references as was the case in the prior art.

Another aspect of the invention relates to the association of plural hyperlinks to a displayed object. When the displayed object is selected by a user mouse click, one of the plural hyperlinks may be activated based on the value of one or more environmental variables. Hence users with differing needs can navigate a single document and traverse customized paths according to their needs. This inventive mechanism allows the HTML code to be structured in a simple unified fashion. Still another aspect of the invention relates to means for supplying user attribute variables to a remote web server without the need for the user to tediously supply the information.

Another aspect of the invention relates to Internet filters which can modify information received over an Internet connection. The Internet filter is operative to modify a received generic HTML data stream and convert it to a customized HTML data stream. The customized HTML stream is modified in accordance with a personal attribute environmental variable to match the received information content to the needs and preferences of the individual user.

### BRIEF DESCRIPTION OF THE FIGURES

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an illustration of a distributed data processing system in which the present invention may be implemented;

FIG. 2 is a block diagram of a data processing system in which the present invention may be implemented;

FIGS. 3A-3D are diagrams of screens from a multimedia program illustrating automatic customization of displayed information content based upon specified attributes in accordance with a preferred embodiment of the present invention;

FIGS. 4A-4D are illustrations of web pages displayed on a data processing system using processes in accordance with a preferred embodiment of the present invention;

FIG. 5 is a flowchart illustrating processes of a program using one or more personal attribute environmental variables in accordance with a preferred embodiment of the present invention;

FIG. 6 is a flowchart of a process for customizing presentation of information in a stand alone program in accordance with a preferred embodiment of the present invention;

FIGS. 7A and 7B are a diagram of pseudo code for a stand alone program in accordance with a preferred embodiment of the present invention;

FIG. 8 is a diagram illustrating text displayed on a screen after executing the program in FIGS. 7A and 7B;

FIG. 9 is a flowchart of a process for handling conditional tags in accordance with a preferred embodiment of the present invention;

FIG. 10 is a diagram of tags used for customizing display of information to a user in accordance with a preferred embodiment of the present invention;

FIG. 11 is a flowchart of a process for handling a conditional hyperlink in accordance with a preferred embodiment of the present invention;

FIG. 12 is an illustration of a conditional hyperlink in accordance with a preferred embodiment of the present invention;

FIG. 13 is a diagram of an HTML program in accordance with a preferred embodiment of the present invention;

FIGS. 14A and 14B illustrate web pages returned in response to user input to the HTML program illustrated in FIG. 13;

FIG. 15 is a block diagram illustrating a filter program in accordance with a preferred embodiment of the present invention;.

FIG. 16 is a flowchart of a process for handling HTTP information received from a remote web server in a filter program in accordance with a preferred embodiment of the present invention;

FIG. 17 is a block diagram illustrating a web browser plug-in accordance with a preferred embodiment of the present invention;

FIG. 18 is a diagram HTTP packet header as sent by a browser making a request for information across the Internet in accordance with a preferred embodiment of the present invention; and

FIG. 19 is a web server design in accordance with a preferred embodiment of the present invention.

### DETAILED DESCRIPTION OF THE PREFERRED EMBODIMENT

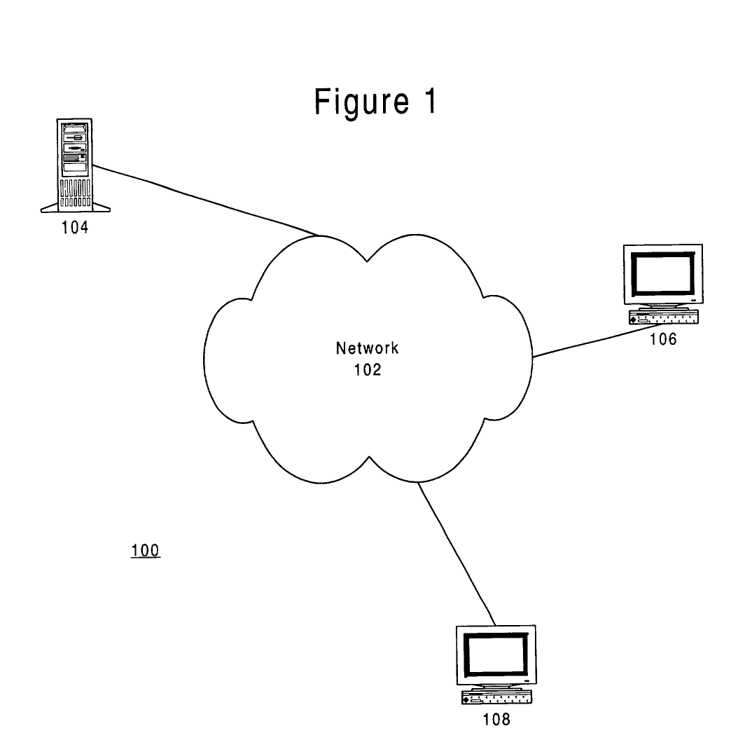

With reference now to the figures, and in particular with reference to FIG. 1, an illustration of a distributed data processing system is depicted in which the present invention may be implemented. Distributed data processing system 100 includes a network 102 for providing communication and data transfer between data processing systems 104, 106, and 108. In the depicted example, network 102 is the Internet, which is a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Data processing system 104 is a web server that provides web pages to data processing systems 106 and 108. The processes of the present invention may be implemented within distributed data processing system 100 in data processing systems 104, 106, and 108. These processes may be implemented in these data processing systems 106 and 108 in a stand-alone fashion or through communications links to data processing system 104.

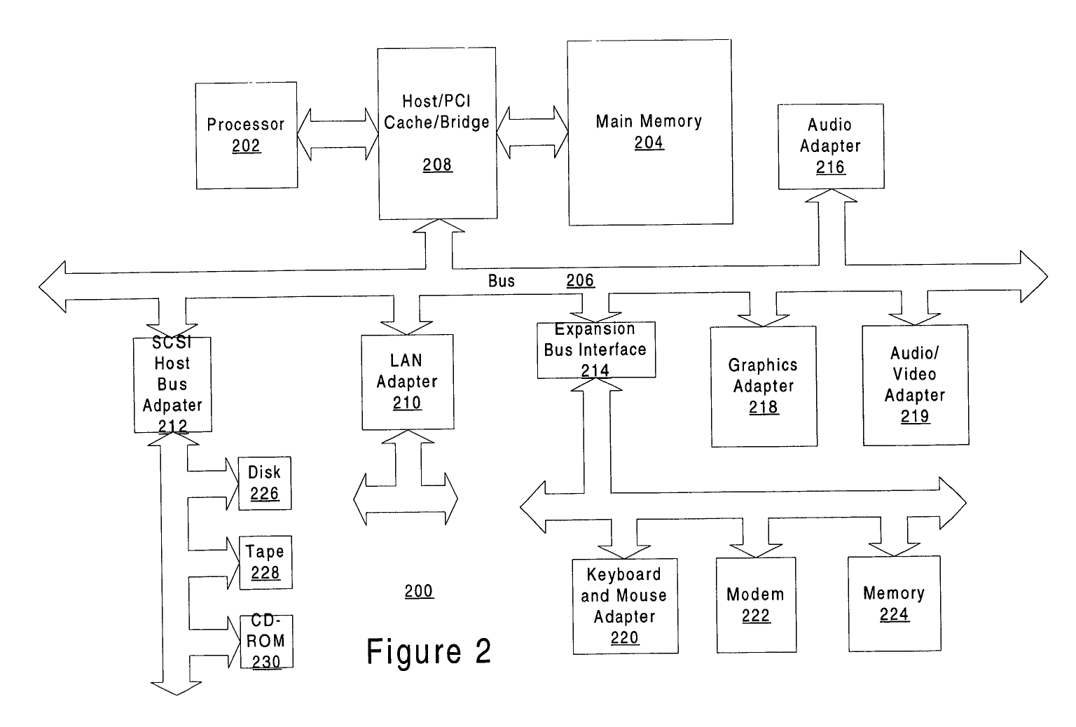

Turning next to FIG. 2, a block diagram of a data processing system 200 in which the present invention may be implemented is illustrated. The processes to provide dynamic customization of displayed information content based upon specified attributes of a human user may be implemented within data processing system 200. Data processing system 200 employs a peripheral component interconnect (PCI) local bus architecture. Although the depicted example employs a PCI bus, other bus architectures such as Micro Channel and ISA may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter (A/V) 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM 230 in the depicted example. Typical PCI local bus implementations will support three or four PCI expansion slots or add-in connectors. The depicted example includes four loads on the motherboard and three expansion slots. Those of ordinary skill in the art will appreciate that the hardware in FIG. 2 may vary. For example, other peripheral devices, such as optical disk drives and the like may be used in addition to or in place of the hardware depicted in FIG. 2. The depicted example is not meant to imply architectural limitations with respect to the present invention.

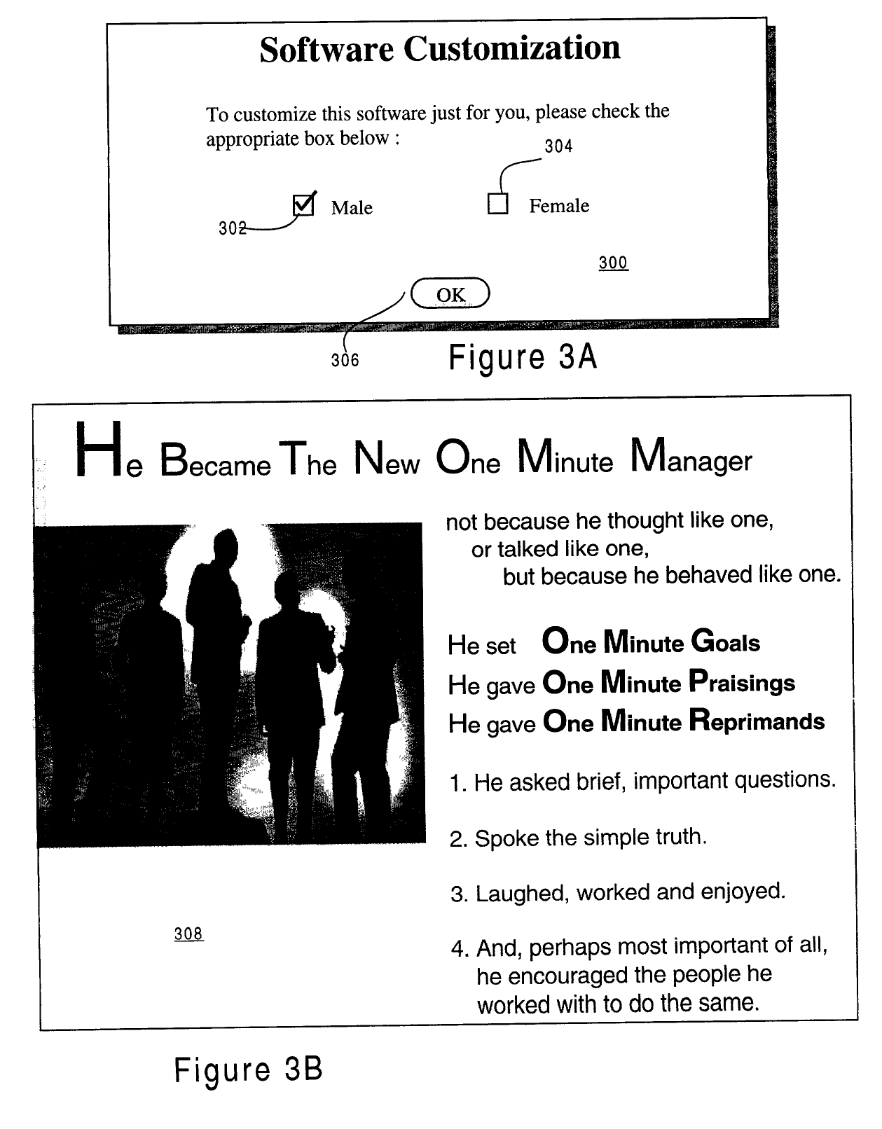

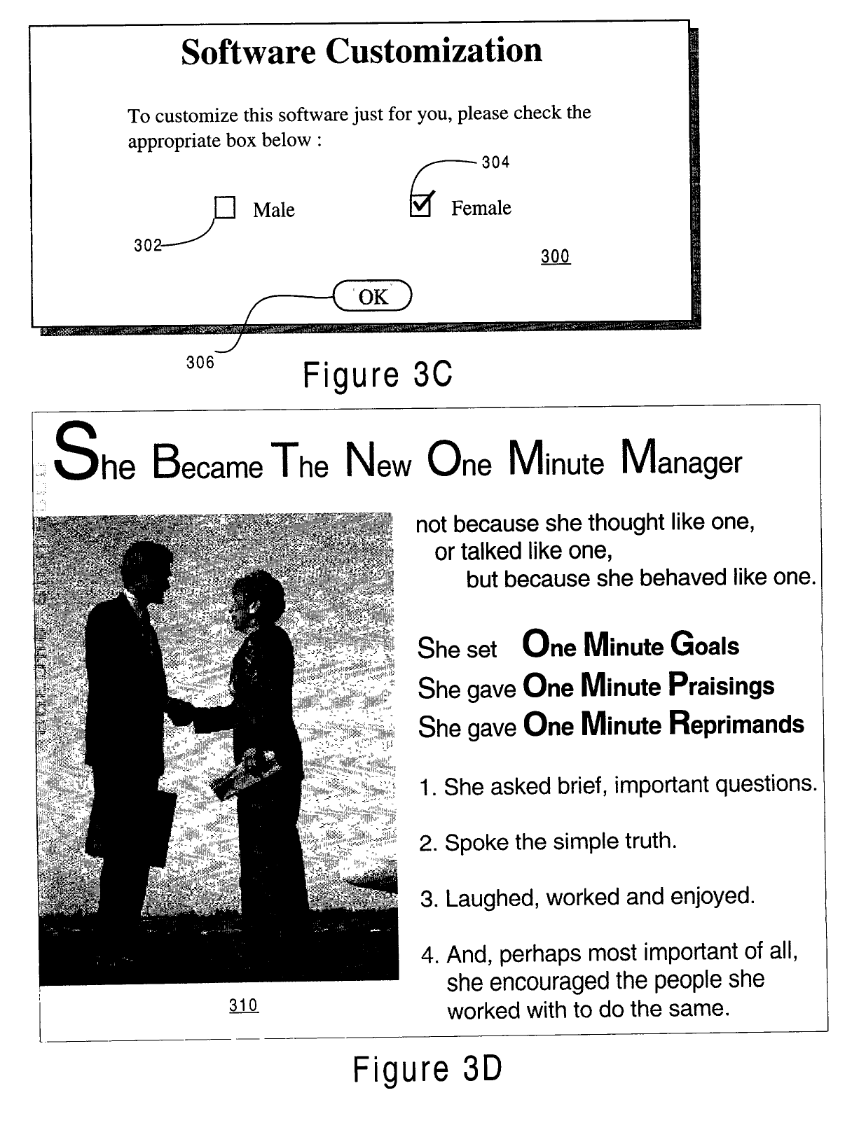

With reference next to FIGS. 3A-3D, diagrams of screens from a multimedia program illustrating automatic customization of displayed information content based upon specified attributes is depicted in accordance with a preferred embodiment of the present invention. According to one embodiment of the present invention, the installation program may request user attributes, such as, for example, gender as part of the customization of the program. In FIG. 3A, dialog 300 requests the user to indicate whether the user is a male or female by selecting boxes 302 or 304, respectively. After the selection is made, the user will select okay button 306 to continue installation of the program. In the depicted example, the user has selected box 302, indicating that the user is a male. In response to this user attribute, the program will display information, including text and graphics, directed towards a male, as illustrated in screen 308 in FIG. 3B. In this particular example, the software in use is a program created to help one become a better manager. The opening screens create and portray an image of a successful manager, helping the user of the program start seeing themselves as a successful manager. The user can better relate to the image being present if the role model used is of the same gender as the user. In FIG. 3C, the user has selected box 304, indicating that the attribute for gender is female, resulting in screen 310 in FIG. 3D being presented to the user instead of screen 308.

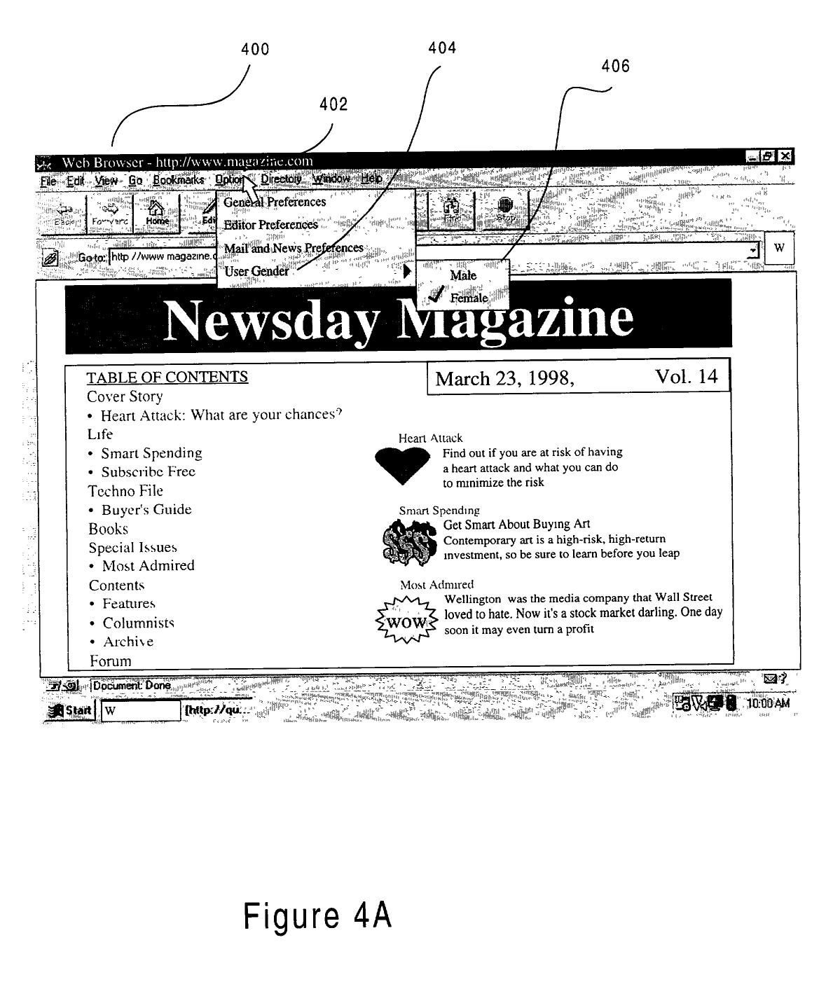

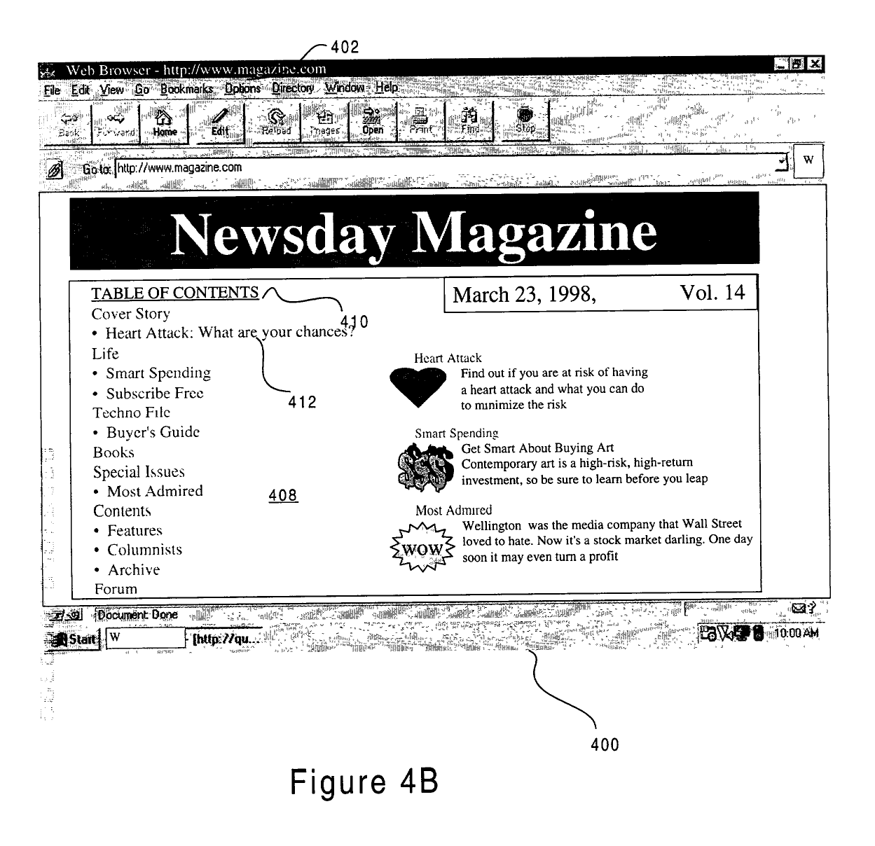

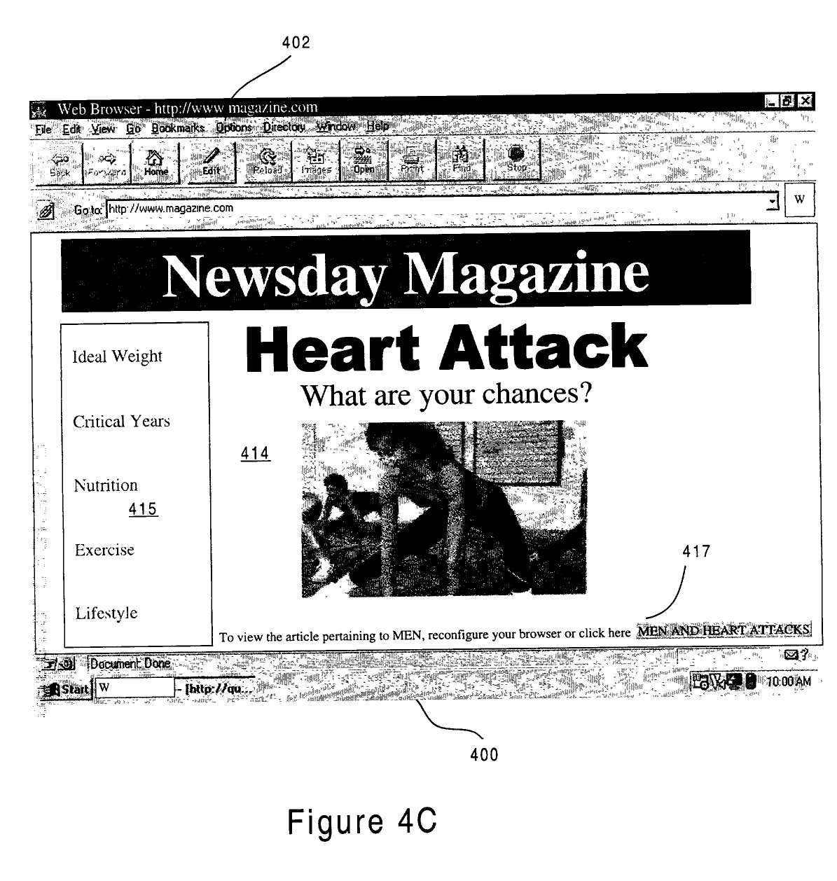

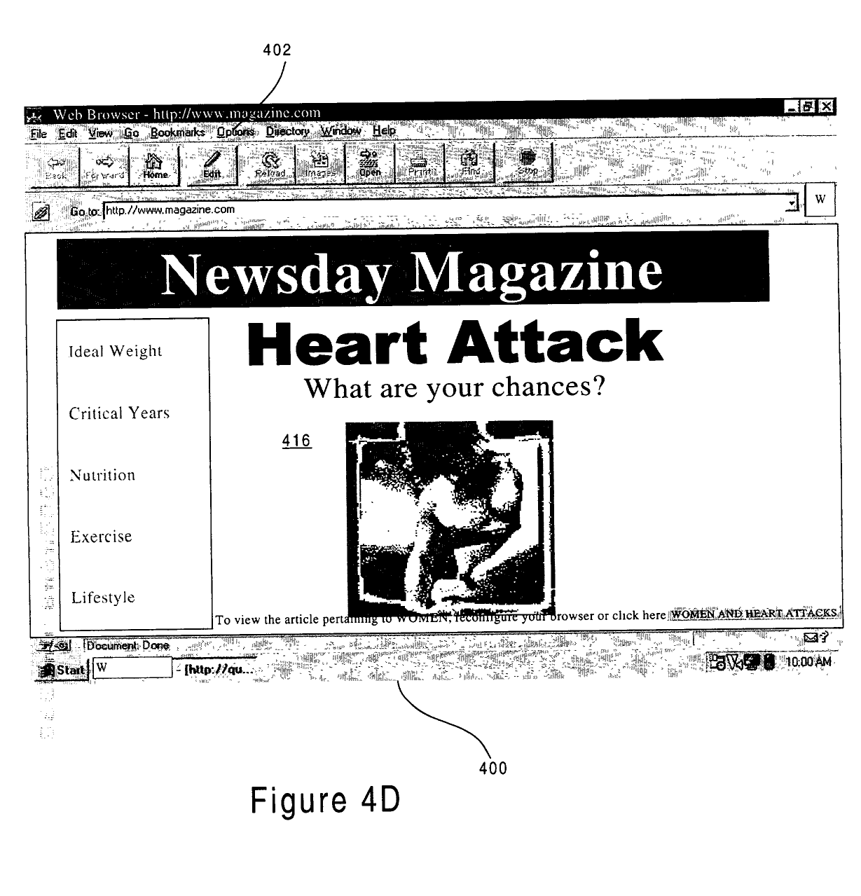

Turning next to FIGS. 4A-4D, illustrations of web pages are displayed on a data processing system using processes of the present invention are depicted in accordance with a preferred embodiment of the present invention. When browsing different web sites, a user may select attributes in a fashion similar to the selection of attributes of customization of a program application. In the depicted example in FIG. 4A, web browser 400 includes an options menu 402, which includes a user gender option 404 in which a user may select male or female from dialog 406. In the FIG. 4A, the user has selected female. Based on the attributes selected, web sites may provide information to a user based on specified attributes of the user. In FIG. 4B, a user may select from various links from web page 408 on web browser 400. For example, under table of contents 410 is a link 412 entitled “Heart Attack: What are your chances?” When link 412 is selected, the web site will return the appropriate information based on the gender option selected by the user. If the attribute is a gender attribute with a female entry selected, web page 414 in FIG. 4C would be displayed to a user on web browser 400. In the depicted examples, a web page is a document on the World Wide Web. A web page consists of an HTML file, with associated files for graphics and scripts, in a particular directory on a particular machine (and thus identifiable by an URL). Usually a web page contains links to other web pages. A web browser is a client application that enables a user to view HTML documents on the World Wide Web, another network, or the user's computer. If the hypertext in section 415 is selected, the information retrieved will pertain to females and heart attacks. Selection of button 417 provides the user a choice of viewing information pertaining to men, in the event that it is what the user is looking for. In FIG. 4D, web browser 400 displays web page 416 based on a male entry for a user attribute. The mechanisms for customizing presentations to a user via the Internet is described in more detail below. Of course a default web page may be sent if no attribute is selected by the user. This default may be one of the genders or yet another set of web pages.

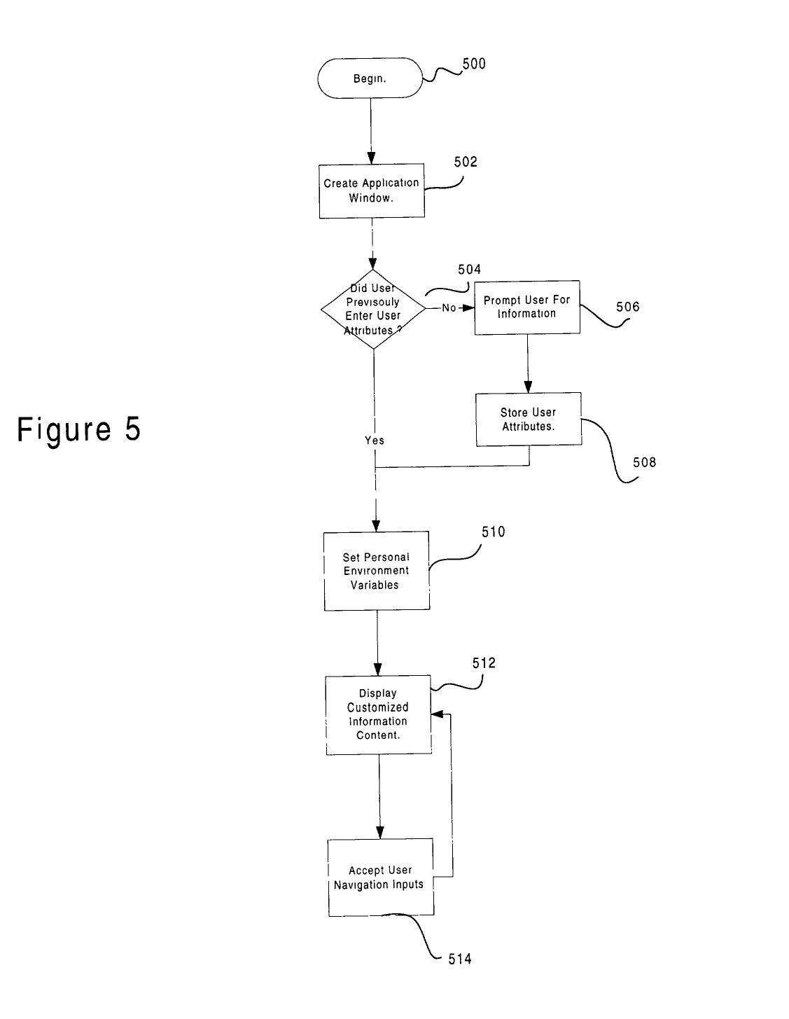

Turning next to FIG. 5, a flowchart illustrating the processing of a program using one or more personal attribute environmental variables is depicted in accordance with a preferred embodiment of the present invention. The process is entered at an entry point wherein a program or an interactive document is invoked (step 500). In a preferred embodiment, the processes of the present invention are implemented either in a program or in the form of an interactive document. An interactive document may be, for example, any electronically published material such as created through an HTML. A user may interact with an interactive document using various means to include mouse clicks, a keyboard, or even an audio-to-text user interface. In a more general sense, an interactive document may include a user interface of a computer program by which a user interacts with the computer program.

After invocation at entry point, an application window is created and presented to the user (step 502). Once the application window is created and displayed to the user, control next proceeds to determine whether the user previously entered user attributes (step 504). If the user did not previously enter user attributes, the user is prompted to enter user attribute information (step 506) and the attribute information is stored in user attribute environmental variables (step 508). The user attribute environmental variables are written to a means for storing the environmental variables in step 508. The storing means may include any type of electronic memory, for example a RAM, EEPROM, disk, tape or other medium. In its simplest form, step 506 displays a user attribute prompt form into which the user enters user or personal attribute information. In practical embodiments, the interactive document may save user attribute information into a file the first time it is entered. Thereafter, when the user enters a user identification attribute such as a user name, the user attribute information may be retrieved without prompting the user. As will be discussed in more detail below, if the process is performed across an Internet connection, user-personal-attribute information may optionally be transferred between a user's web browser and a web site hosting the inventive process automatically without the user's explicit intervention.

Once the user attribute information has been obtained in steps 506 and 508, personal environment variables are set (step 510). The process also proceeds to step 510 if user attributes had been previously entered back in step 504. In step 510, a set of personal environment variables is written with a set of values determined by the user attribute information obtained in step 506. After the personal environment variables are written in step 510, customized information content is displayed to the user (step 512). In step 512, information content is displayed based on the personal environment variables. Once a screen or window of information is displayed to the user in step 512, the process accepts user navigation inputs to navigate within the program in a stand alone version or to navigate to other web pages or web sites in an Internet version (step 514). A stand alone program is a program that does not require support from another program located on another system, for example, a program executing on a computer that is not connected to a network or the Internet. User inputs may be received in various forms. User inputs are typically received in the form of mouse clicks entered by the user after positioning the cursor over a displayed object. Alternatively, keystrokes may be entered after positioning the cursor over an input box. After a valid user input is received in step 514, the process returns to step 512, wherein another display is generated for view by the user. Each time step 512 is performed, the personal environment variables may be accessed to control the display of customized information content. Control of the process loops between step 512 and step 514 as the user navigates through the customized interactive program or document.

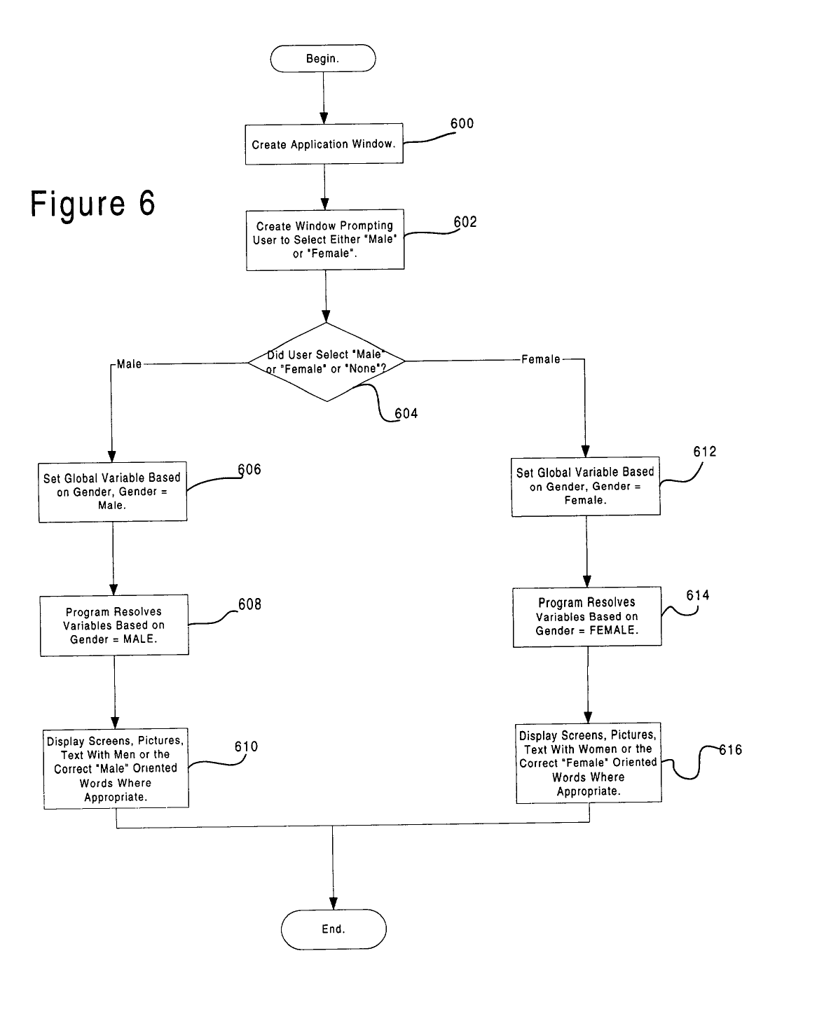

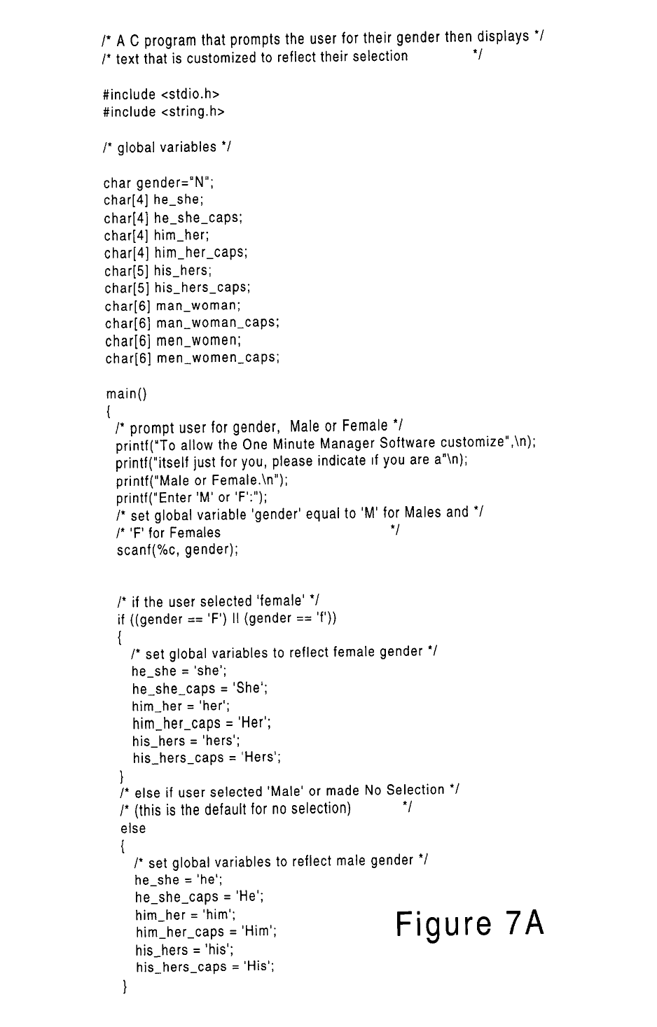

Turning now to FIG. 6, a flowchart of a process for customizing presentation of information in a stand alone program is depicted in accordance with a preferred embodiment of the present invention. The process begins by creating an application window that is displayed to the user (step 600). Then, a window or dialog is created, prompting the user to select either a male or female option (step 602). Step 602 is performed during installation of the program. Alternatively, the user may select the option from a program menu. A determination is then made as to which option the user selected (step 604). If the male option was selected, the process then sets a global variable based on gender in which the gender is set equal to male (step 606). Thereafter, variables in the program are replaced based on the variable gender equal to male (step 608). For example, wherever variables are present based on gender, appropriate male based terms, such as he, him, or his may be substituted where specified. Display screens, pictures, text with men or correct male oriented words are presented to the user when appropriate (step 610). The appropriate places for substitution or gender changes are determined by the creator of the program or electronic document.

With reference again to step 604, if the female option was selected, the process then sets the global variable based on gender in which the gender is set equal to female (step 612). The program then replaces variables based on the variable gender equal to female (step 614). For example, whenever variables are present based on gender, appropriate female based terms, such as she, her, or hers may be substituted or specified. Display screens, pictures and text with female or the appropriate female oriented words are presented to the user when appropriate (step 616).

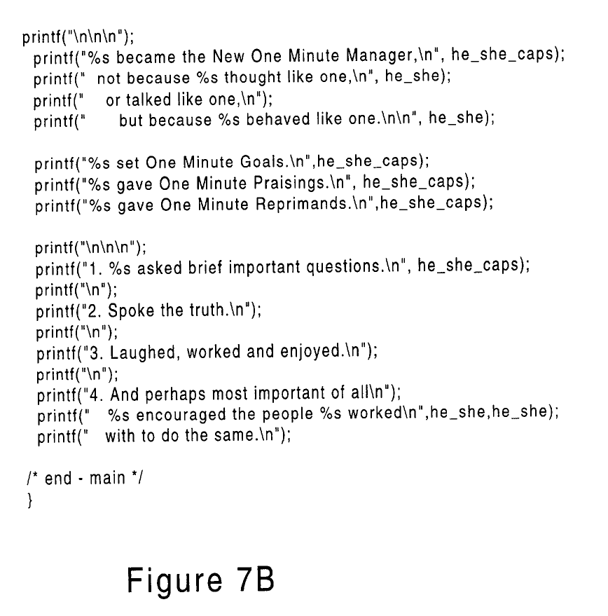

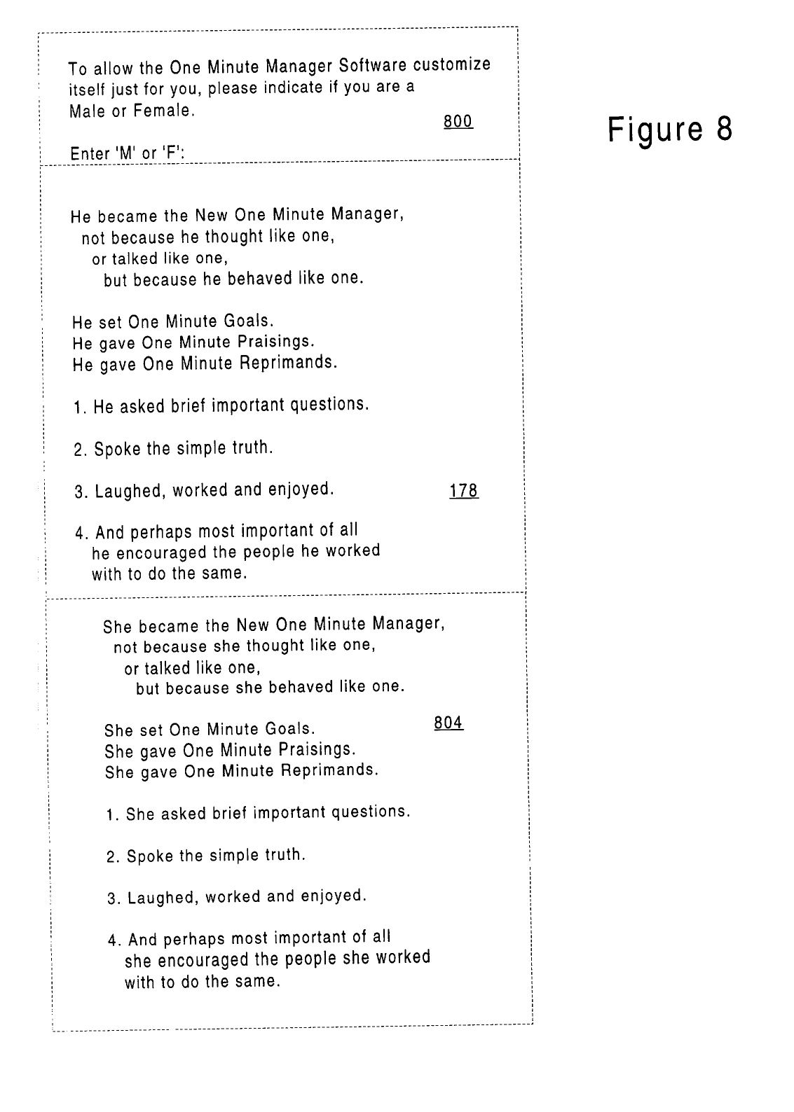

Turning now to FIGS. 7A and 7B is a diagram of pseudo code for a stand alone program in accordance with a preferred embodiment of the present invention. The code in FIGS. 7A and 7B is written in C and generates text displayed in FIGS. 3B and 3D in response to selections similar to those made in FIGS. 3A and 3C. More specifically, The text in section 1800 of FIG. 8 is displayed using the pseudo code from FIGS. 7A and B. If a male selection is made the text in section 802 is displayed to the user. Text in section 804 is displayed in response to a female selection by the user of the program.

The present invention includes the use of standard replacement variables that may be incorporated into the code and design of a web browser. Table 1 below provides an example of standard replacement variables in the form of a sample set of gender variables that a web browser may define and incorporate in its code and design. Once defined and understood by the web browser, these variable names are published for use by any web page creator. When a web browser encounters one of these variables, the web browser will (1) check which gender option, male or female, has been selected and (2) substitute the correct word in place of the variable based on the gender selection. These replacements may be used in the processes depicted in the description of FIG. 6 above. These standard gender variables may be used in the various embodiments illustrated below.

TABLE 1

| Variable Name | If gender = M, resolve to: | If gender = F, resolve to |
|---|---|---|
| he_she | he | she |
| he_she_first_letter_caps | He | She |
| he_she_all_caps | HE | SHE |
| him_her | him | her |
| him_her_first_letter_caps | Him | Her |
| him_her_all_caps | HIM | HER |
| his_hers | his | hers |
| his_hers_first_letter_caps | His | Hers |
| his_hers_all_caps | HIS | HERS |
| man_woman | man | woman |
| man_woman_first_letter_caps | Man | Woman |
| man_woman_all_caps | MAN | WOMAN |
| men_women | men | women |
| men_women_first_letter_caps | Men | Women |
| men_women_all_caps | MEN | WOMEN |
| boy_girl | boy | girl |
| boy_girl_first_letter_caps | Boy | Girl |
| boy_girl_all_caps | BOY | GIRL |
| boys_girls | boys | girls |
| boys_girls_first_letter_caps | Boys | Girls |
| boys_girls_all_caps | BOYS | GIRLS |

These definitions would be handled entirely by the web browser. Of course, other types of standard replacement variables may be employed, such as, for example, standard replacement variables based on culture or age.

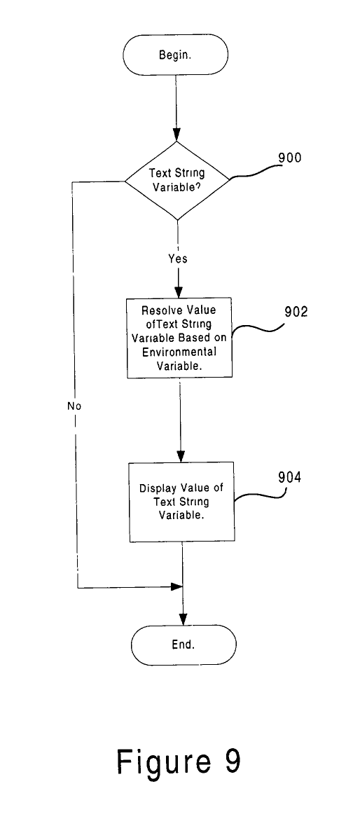

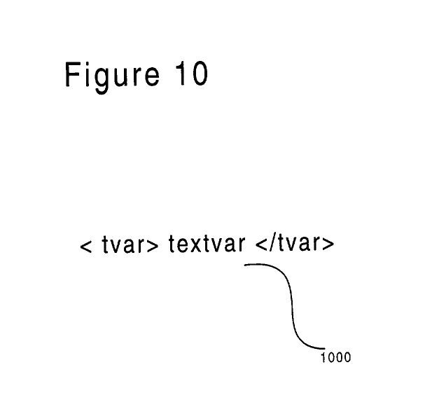

In the case in which the present invention is implemented using an interactive document, a single interactive document structure may be provided which makes use of HTML-like tags to conditionally display information. With reference to FIG. 9, a flowchart of a process for handling conditional tags is depicted in accordance with a preferred embodiment of the present invention. The process begins by determining whether a tag in the form of a text string variable has been encountered (step 900). A tag is defined that represents a text string variable. For example, in FIG. 10, line 1000 includes “<tvar>”, indicating that “textvar” is a variable, which evaluates to a text string. If a text string variable has been encountered, the value of the text string variable is obtained (step 902), and the value of the text string variable is displayed (step 904). If a text string variable has not been encountered, the process returns to step 900. More specifically, when the HTML display processor encounters the tvar tags, it looks up the text string value of textvar and displays this value. For example, if the user has entered a female gender attribute, then textvar may evaluate to “she,” and if the user has entered a male gender attribute, then textvar may evaluate to “he.” Similarly, in various examples involving humans, different string variables may be used to evaluate male or female names. Note that a browser implemented with this aspect of the invention needs to be modified over prior art browsers with the addition of the use of environmental variables (i.e., male, female or none), and standard replacement variables (i.e., Table 1) which control the output generated from string variables located between tvar tags (or their equivalents).

Personal attribute environmental variables may also be used to impact the flow of navigation through the interactive document. Instead of simple text string variable substitutions, the environmental variables may be used to conditionally activate one of a plurality of hyperlinks. According to an aspect of the present invention, a browser program is modified so that when the user clicks on a displayed object, one of a plurality of hyperlinks is selected based upon the value of at least one environmental variable. This is advantageous because in some cases the requisite alteration of the information content in the interactive document may be more involved than simple textual gender substitutions. In one example, the user may be reading a gender-customized segment and select a hyperlink that invokes an image. If the gender variable is set to male, an image involving a male may be appropriate whereas if the gender variable is set to female, an image involving a female may be appropriate. In another example, the content may be based on age. Adult viewers may receive one version of the presentation while teens may receive a completely different version. In this case simple substitutions are not sufficient, but rather the entire presentations may differ. An age-environmental variable is employed to control whether a mouse click selects a hyperlink to information catering to kids, teens, or adults. A similar level of hyperlink selectivity may be suitable when different versions of content are provided targeted to readers of different ethnic or cultural backgrounds.

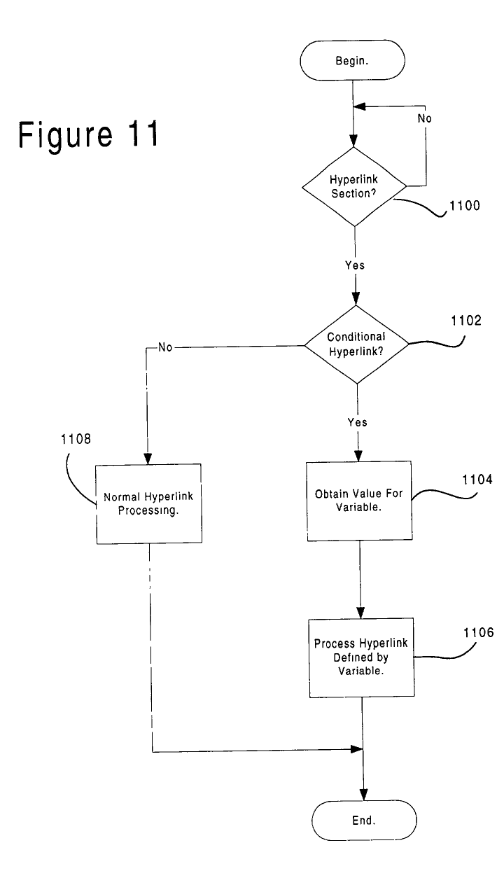

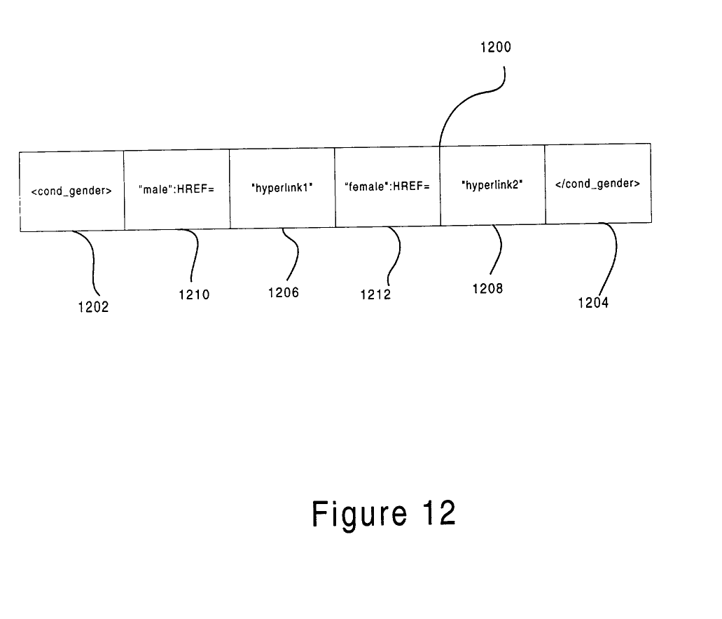

FIGS. 11 and 12 depict the process flowed in response to a user clicking on a conditional hyperlink, such as link 412 in FIG. 4B. With reference now to FIG. 11, a flowchart of a process for handling a conditional hyperlink is depicted in accordance with a preferred embodiment of the present invention. The process begins by determining whether a hyperlink has been selected (step 1100). If a hyperlink has not been selected, the process then returns to step 1100. If a hyperlink has been selected, the process then determines whether the hyperlink is a conditional hyperlink (step 1102). If the hyperlink is a conditional hyperlink, the value of the variable for the conditional hyperlink is obtained from a storage device, such as, for example, a memory or disk (step 1104). The process then processes the hyperlink associated with the value of the variable (step 1106) with the process terminating thereafter. In the examples shown in FIGS. 4A-4D, this would result in the web page in FIG. 4C or FIG. 4D being returned. With reference again to step 1102, if the hyperlink is not a conditional hyperlink, then normal hyperlink processing occurs (step 1108) with the process terminating thereafter.

Conditional hyperlinks may be implemented according to the present invention using a language construct similar to a C-language switch statement. A conditional hyperlink may be encoded within an HTML document as illustrated in FIG. 12. Conditional hyperlink 1200 includes conditional activation tags 1202 and 1204, in which “cond_gender” is conditional activation tag conditioned on the variable “gender”. Conditional hyperlink 1200 includes hyperlinks 1206 and 1208, which are illustrated using “hyperlink1” and “hyperlink2”, respectively in the depicted example. In an implementation, “hyperlink1” and “hyperlink2” are fields that would be substituted with a valid address within the interactive document or to an external Internet address as commonly practiced in prior art HTML. Within conditional activation tags 1202 and 1204 are two specifiers, 1210 and 1212, respectively, “male”:HREF= and “female”:HREF=. This is similar to a switch statement in the C programming language. If the variable “gender” evaluates to the string “male,” then hyperlink 1206 should be activated, while if the gender variable evaluates to the string “female,” then hyperlink 1208 should be activated. In general, a variable with more than two possible values may be specified in a conditional activation tag, and any number of conditional hyperlinks may be enclosed between the conditional activation tags. For example, a third hyperlink could be added to conditional hyperlink 1200 in which the specifier could evaluate to a third string of null or none in the case that a user has not selected a gender. The third hyperlink could have an address to a third set of web pages or to one of the two web pages for the male or female gender depending on the web page design.

Also, the variable “gender” is given by way of example and may generally take on any given variable name. In different embodiments, environmental variables may take on non-string values. Note that the above illustrates an example syntax, and equivalent effects can be achieved with a different syntax as may be designed into mark-up languages without deviating from the scope of the inventive concept. Any browser modified to parse HTML to selectively activate hyperlinks based on an environmental variable is within the scope of the invention. Any web server or web site that supplies HTML code with conditional hyperlinks is also within the scope of the invention as well as HTML code with conditional hyperlinks based on user attributes or environmental variables. Conditional tags similar to those described in FIG. 12 also could be used to conditionally change the presentation, such as, for example, display images or play sounds, based on the variable “gender”, as further illustrated below.

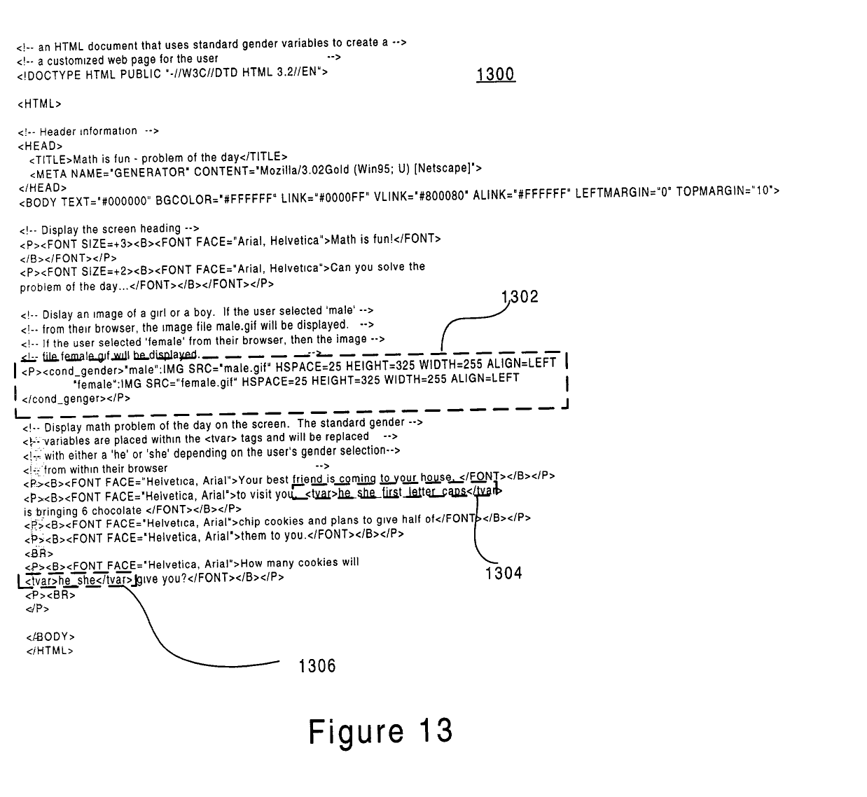

Turning to FIG. 13, a diagram of an HTML program is depicted in accordance with a preferred embodiment of the present invention. Program 1300 is used to return a web page to a user that selects a web address: http://www.mathisfun.com. Program 1300 includes a conditional statement 1302 that returns a first graphic or a second graphic depending on the resolution of the variable “gender”. Program 1300 also includes conditional tags 1304 and 1306 that contain standard replacement variables in the form of gender replacement variables, as defined in Table 1. These variables would be predefined and understood by the web browser and during execution will be replaced with the correct word.

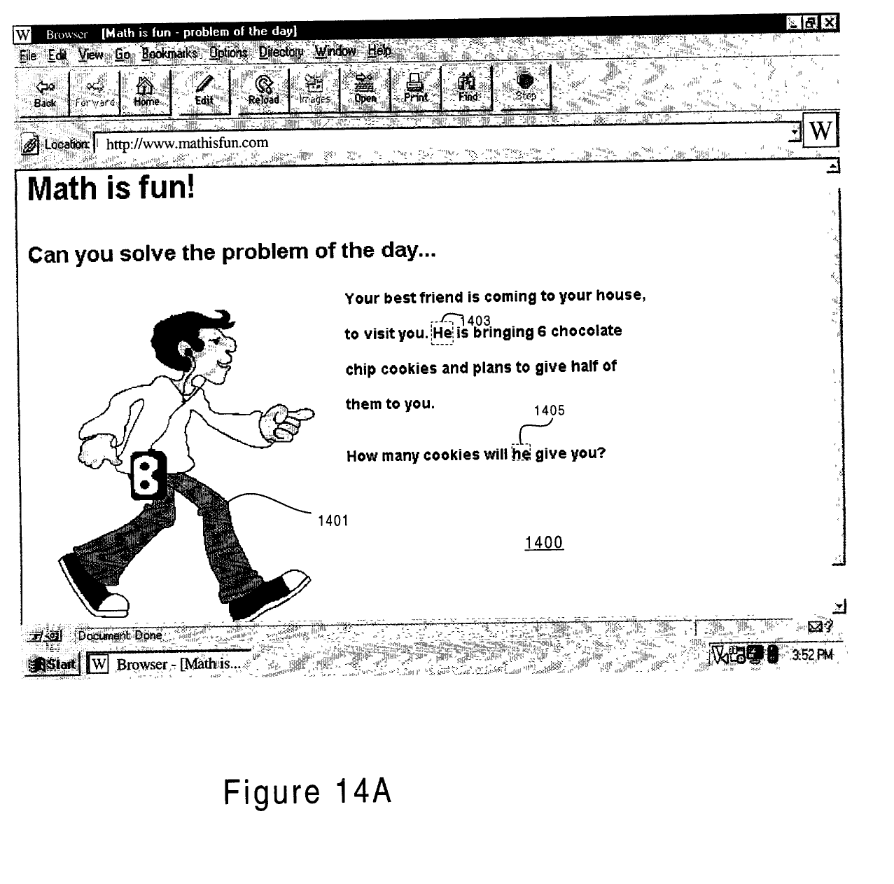

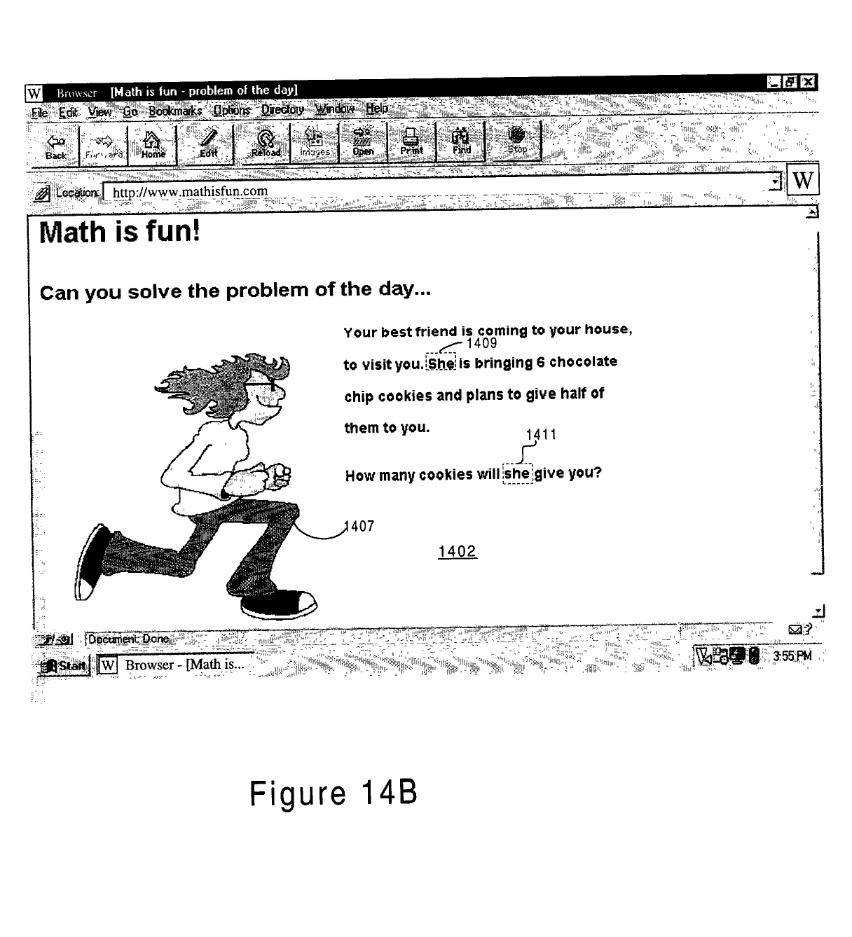

FIGS. 14A and 14B illustrate web pages returned in response to user input to the HTML program illustrated in FIG. 13. In particular, web page 1400 is returned from the HTML code in FIG. 13 when the web browser option ‘Male’ is selected and web address: http://www.mathisfun.com is accessed. An image of a male character 1401 and text referring to a male friend 1403 and 1405 are displayed. Web page 1402 returned from the HTML code in FIG. 13 when the web browser option ‘Female’ is selected and the exact same web address: http://www.mathisfun.com is accessed. An image of a female character 1407 and text referring to a female friend 1409 and 1411 are displayed.

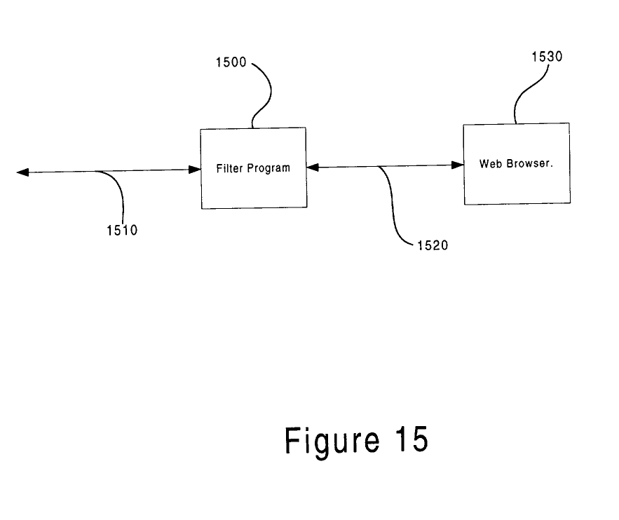

With reference now to FIG. 15, a block diagram illustrating a filter program is shown in accordance with a preferred embodiment of the present invention. In this embodiment, the present invention takes the form of a filter program, which connects, between a standard web browser and a TCP/JIP connection. The filter program may implement standard gender variables as described above. The filter program 1500 includes a first interface 1510 connected to a socket connection to a dialer and a TCP/IP protocol stack. Filter program 1500 also includes a second interface 1520 which provides a software connection to a browser program 1530. The filter program may be implemented in a standard programming language such as C or C++, and the interfaces may be implemented with operating system socket application program interfaces (APIs) used for interprocess communications and for communicating with TCP/IP protocol stack processors. For example, if the filter is implemented in a Windows 95 environment, filter program 1500 may be implemented as a .DLL executable, FILTER.DLL. The FILTER.DLL program intercepts all socket communications between any Internet application and WSOCK32.DLL. The program monitors all data, parses the HTTP protocol, and has the capability of modifying the HTML on the fly. Internet socket connections are accessed within the filter program using the WinSock or WinInet APIs.

In operation, the browser 1530 acts as a client process connected to a socket. The browser 1530 sends client requests to the socket interface 1520 as though the filter program 1500 were not present. Filter program 1500 is configured to provide the same type of socket interface to which the browser normally connects. Filter program 1400 intercepts all transmissions and connects the browser to the Internet via to the socket connection 1510. Filter program 1500 receives the requests issued by the browser which mainly include HTTP protocol get commands for requesting information from a remote web server. Filter program 1500 simply passes the HTTP requests received from the browser on socket interface 1520 and passes the requests out to the TCP/IP connection via socket interface 1510.

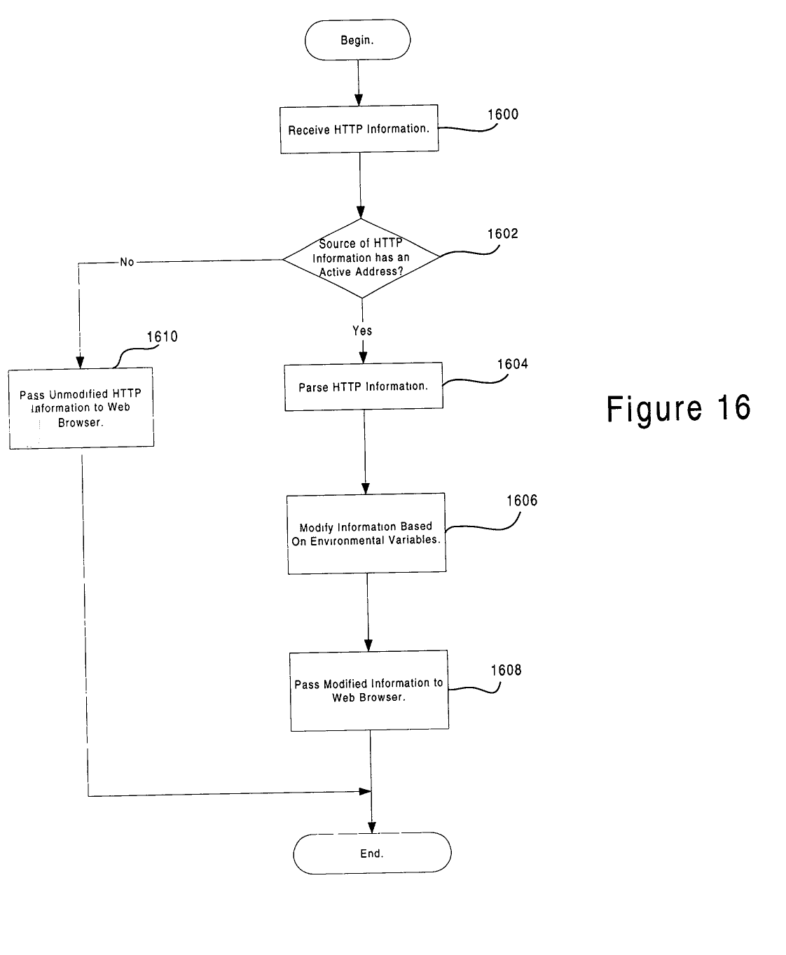

Turning now to FIG. 16, a flowchart of a process for handling HTTP information received from a remote web server by a filter program is depicted in accordance with a preferred embodiment of the present invention. Filter program 1500 next awaits the receipt of the requested HTTP information from the TCP/IP connection. The process begins by filter program 1500 receiving HTTP information from the web server (step 1600). When HTTP information is received, a determination is made as to whether the information is from an active address (step 1602). An active address indicates that the web server at that address is one that is enabled to provide user specific information for processing by filter program 1500. Since filter program 1500 has direct access to the HTTP data stream, the program can be configured to only make the substitutions for particular server HTTP addresses (active addresses) corresponding to specified types content, for example, for distance learning.

Upon determining that the source of the HTTP information has an active address, filter program 1500 parses the HTML code received over interface 1510 (step 1604) and modifies the HTML code based on the values of the environment variables (step 1606). For example, filter program 1500 may perform natural language parsing as is known in the art and replace instances of male names with female names and instances of “he” with “she.” The modified information is then passed to the web browser by filter program 1500 (step 1608) with the process terminating thereafter. With reference again to step 1602, if the source of the HTTP information does not have an active address, the unmodified HTTP information is passed to the web browser (step 1610). While it may be desirable to alter names and gender references when viewing training materials, it would not be desirable when viewing a news story.

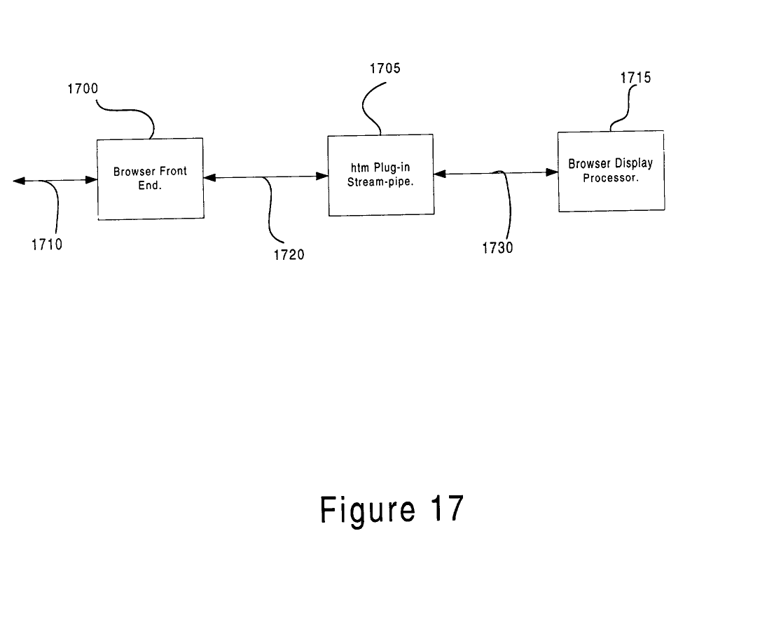

Turning now to FIG. 17, a block diagram illustrating a web browser plug-in is illustrated in accordance with a preferred embodiment of the present invention. This embodiment is similar to the embodiment of FIG. 15, except the filter program is implemented as a plug-in within the web browser. The plug-in may define and replace standard gender variables as described above in Table 1. The browser is connected via socket connection 1710 to a TCP/IP protocol stack in the standard way. Browser-internal software link 1720 is used to connect the input stream of HTML data to plug-in program 1705. Browser front end 1700 receives the HTTP data stream from the socket connection and passes data of a specified file type to plug-in program 1705. To implement the filter program, the plug-in program is configured to receive .htm (HTML) file types. Plug-in program 1705 provides a filtering operation to the HTML data and sends processed output over browser-internal software connection 1730 to the browser's display processor 1715. Display processor 1715 is operative to display the customized HTML code into a display window for viewing by the user.

In connection with the above embodiment, a “plug-in” is a program called by the browser every time a file of a given type is received over connection 1710. For example if a file with a .JPG extension is received, a plug-in may be called to process this file type. A .JPG file is a JPEG compressed image file, and a .JPG plug-in would be a JPEG image viewer program. In the embodiment of the present invention, plug-in program 1705 is a filter program called every time a .htm file is received. The filter program maintains a set of user-attribute variables and uses these variables to alter the HTML information content by making specified substitutions such as replacing all instances of “he” with “she” where appropriate as specified by the web page creator. In an implementation involving a Netscape browser, the modified HTML code is passed between the Netscape browser and the plug-in via a stream construct. Data may be transmitted from plug-in program 1705 back to browser display processor 1715 using the NPP_Write command. For details of programming Netscape plug-ins, see L. Duncan and S. Michaels, “Netscape Technologies Developers Guide,” Ventana Publishing, 1997.

When using a filter, the filter may be constructed such that gender changes or substitutions are made in response to detecting tags or indicators from the web page. One approach is for the web server to directly supply user-customized information content using the inventive process discussed in connection with FIG. 5. Using the process of FIG. 5, an Internet web site may deliver information content customized for a given user. Because the Internet user may not prefer to fill out information forms for each user-customized site, a need arises for a means to allow an Internet user to supply user-attribute information to a user-customized content provider seamlessly without the user's constant intervention and without modifications to presently available browsers. The discussion below provides enabling techniques to allow a client browser to automatically provide user attribute information to a web server. Unlike the embodiment discussed above wherein the browser parses string variables and/or conditional HREF commands, the embodiments below assume the user has a standard browser. In this embodiment the browser only needs to supply user attribute information to the web server using available techniques. The web server on the Internet then delivers customized information to the web browser without the need for the browser to be enhanced.

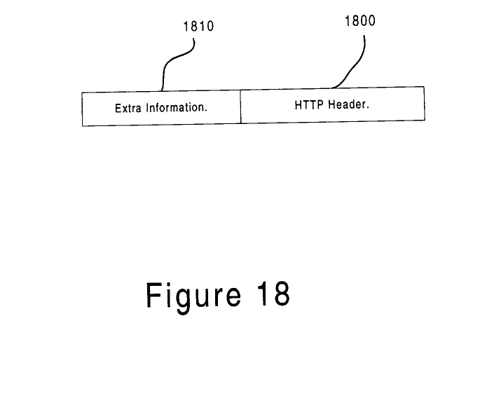

Turning now to FIG. 18, an HTTP packet header as sent by a browser making a request for information across the Internet is illustrated in accordance with a preferred embodiment of the present invention. The HTTP request packet contains an HTTP header 1800 and an additional information field 1810. Specific details of the information contained in the HTTP header may be found on pages 272-275 of R. Burk et. al, “TCP/IP Blueprints,” Sam's Publishing 1997. The HTTP header includes information regarding the client browser type, the URL of the client, as well as other information relating to the message encoding and access method. Beside the HTTP header, a browser may attach non HTTP 1.1 header fields, which may optionally be used or discarded by a web server. According to an aspect of the present invention, these additional fields may be used to append user-attribute data indicative of gender, race, age group of the user. As is well known in the art, a common gateway interface (CGI) script may be executed by the server program to parse the HTTP header so as to extract client related information. A CGI script may be written to scan for the additional field and extract the user-attribute variables sent by the client with the HTTP header with every mouse click. As personal attribute information may be deemed sensitive, a client browser and a remote server may employ various known forms of encryption such as public key encryption to protect the information.

Another way for a client to communicate user-attribute information over the Internet is via a data construct known in the art as a “cookie”. A “cookie” is an entry in a text file residing on the browser's local hard drive. Cookies are used to maintain consistent state information between browsers and sites. A JavaScript may be used to read, write and delete cookies. A JavaScript located on a remote server may send a cookie to a client browser as a query to obtain information from a local cookie located on the browser's hard drive. Hence a server site may obtain user-attribute information from a browser via a cookies transaction. Detailed examples of how cookies may be used to perform various types of transactions may be found in Harold Davis, “Web Developer's Secrets,” IDS Books Worldwide, 1997, and the accompanying CD-ROM. Hence using cookies, a user may enter user attribute information into a local database, and then a JavaScript may be executed by an authorized remote server to identify the user and access the stored user attribute parameters.

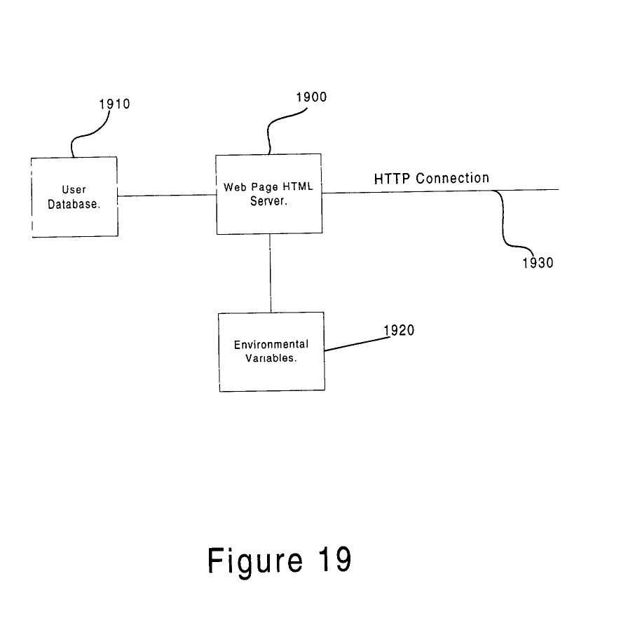

With reference now to FIG. 19, a web server design is depicted in accordance with a preferred embodiment of the present invention. A data processing system includes a web page HTML server 1900 coupled to user database 1910 and a set of one or more environmental variables 1920. The web page HTML server 1900 is coupled to one or more socket connections 1930, which carry HTTP application layer data over a network using TCP/IP transport protocols. In general, a socket connection may include any interface to a network protocol stack process.

Web page server 1900 is operative to receive user attribute data from a client browser, for example from an HTML form, an HTTP header, or a JavaScript cookie. Web server 1900 analyzes the client HTTP header to determine if the user is in the user database 1910. The user attributes are preferably located in a mass storage device such as a hard drive. If information in the HTTP header matches an entry in the user database, then a set of user attribute environmental variables 1920 are preferably loaded into memory. If the HTTP header does not match a known user, then a cookie transaction is attempted to obtain the user data and create and entry. If the cookie transaction fails, the user is presented with an HTML form. If the user refuses to fill out a form, the user is preferably loaded into the database with a generic entry. When the web page HTML server receives HTTP requests, it conditionally supplies information based upon the clicked hyperlink and the environmental variables. In this way the browser does not need to be aware of the user-attribute variables, except possibly to supply user attribute information in the HTTP headers or cookies. If the browser is known to be conversant in user-customized HTML, the server may deliver HTML code to the client browser containing conditional display variables as discussed in connection with FIG. 5.

The customization of presentations may be applied to other aspects other than text. For example, in a multimedia presentation different types of music or videos may be present depending on the personal attribute selected by the user.

It is important to note that while the present invention has been described in the context of a fully functioning data processing system, those of ordinary skill in the art will appreciate that the processes of the present invention are capable of being distributed in a form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not limited to be exhaustive or limited to the invention in the form disclosed. Many modifications and variations will be apparent to those of ordinary skill in the art. Although the present invention has been described with reference to a specific embodiment, other embodiments may occur to those skilled in the art without deviating from the intended scope. For example, in an alternate embodiment, interactive documents based on languages other than HTML may be constructed. Application layer protocols other than HTTP may be used. Transport protocols other than TCP/IP may also be used. The techniques may be applied to various forms of electronic publishing, to include user interfaces in packaged software. Any interactive electronic document that accepts a user input identifying a personal attribute of a user and customizes the presentation based on the supplied attribute is within the scope of the present invention. The embodiment was chosen and described in order to best explain the principles of the invention and the practical application to enable others of ordinary skill in the art to understand the invention for various embodiments with various modifications as are suited to the particular use contemplated. While the invention has been particularly shown and described with reference to a preferred embodiment, it will be understood by those skilled in the art that various changes in form and detail may be made therein without departing from the spirit and scope of the invention.

What is claimed is:

1. An interactive document comprising:
an input operable to receive a personal attribute of a human user; and
an information content delivery system, which presents information content, matched to the personal attribute of the user.

2. The interactive document of claim 1 wherein the personal attribute is the gender of the human reader.

3. The interactive document of claim I wherein the personal attribute is the race of the human reader.

4. The interactive document of claim I wherein the personal attribute is the age of the human reader.

5. The interactive document of claim 1 wherein the interactive document is a user interface to a computer program.

6. The interactive document of claim 1 wherein the interactive document is an HTML document containing hyperlinks.

7. The interactive document of claim 1 wherein the interactive document is a web site whose information is distributed across a network.

8. The interactive document of claim 7 wherein the network is an internet.

9. The interactive document of claim 1 wherein the interactive document is distributed as a CD-ROM.

10. The interactive document of claim 1 wherein information content that is matched to the personal attribute of the user using standard replacement variables.

11. A network server operable to receive requests via a network connection and to respond with information derived from an interactive document, the interactive document comprising:
an input operable to receive a personal attribute of a human user; and
an information content delivery system, which presents information content, matched to the personal attribute of the user.

12. The network server of claim 11 wherein the personal attribute is the gender of the human reader.

13. The network server of claim 11 wherein the input is obtained from a CGI script which reads an HTTP packet header.

14. The network server of claim 11 wherein the input is obtained from a JavaScript Cookie transaction.

15. The network server of claim 11 wherein the input is obtained from an electronic-information form entered remotely via a browser program by the human user.

16. The network server of claim 11 wherein the interactive document is a user interface to a computer program.

17. A network web site providing network access to at least one interactive document, the interactive document comprising:
an input operable to receive a personal attribute of a human reader; and
an information content delivery system which presents information content matched to the personal attribute of the user.

18. The network web site of claim 17 wherein the network is an Internet.

19. An Internet filter program comprising:
a first input/output software connection coupled to a socket interface of an web browser;
a second software input/output connection coupled to a network socket interface; and
a filter program operable to read an information stream received over the second connection, modify the information stream in accordance with at least one user-attribute representative of a human quality of a user, and transfer the modified information stream to the first input/output connection for subsequent use by the web browser.

20. The Internet filter program of claim 19 wherein at least one of the socket interfaces uses the API associated with WSOCK32.DLL.

21. An filter program comprising:
a plug-in program called by an web browser in response to information received over a network connection; wherein
the plug-in program analyzes information received over the network connection, modifies selected portions of the information in accordance with at least one user-attribute parameter representative of a human quality of a user, and forwards selected information to influence a computer display.

22. A method of presenting customized information for display by a computer, the method comprising steps of:
accepting as input a personal attribute of a human user;
displaying electronically published material whose presentation is customized based upon the personal attribute of the human user.

23. The method of claim 22 wherein the published material is customized with respect to the gender of the user.

24. The method of claim 22 wherein the published material is customized with respect to the culture of the user.

25. The method of claim 22 wherein the published material is customized with respect to age of the user.

26. A web browser comprising:
storage means for storing an environmental variable; and
an information content display system, which selectively determines an address of information to be displayed, based on the environmental variable and a user input.

27. The web browser of claim 26 wherein the user input is derived from clicking a mouse after a cursor has been placed over a displayed object.

28. The web browser of claim 26 wherein the selective determination is a method comprising the steps of:
accepting a user input to identify a displayed object;
associating multiple reference tags with a browser code segment associated with the object;
further associating each of the reference tags with a specified value of the environmental variable; and
processing the user input to identify the identified object, using the environmental variable value to select between the reference tags associated with the object, and selecting a hyperlink from the selected reference tag.

29. The web browser of claim 28 wherein the environmental variable is a standard replacement variable.

30. The web browser of claim 29 wherein the standard replacement variable is a standard gender variable.

31. A method of processing an HTTP packet header comprising the steps of:
parsing the HTTP packet header to extract at least one value from a standardized field,
parsing the HTTP header to extract information from a field containing information relating to a personal attribute of an internet user;
setting an environmental variable based upon the personal attribute; and
delivering information across an HTTP connection wherein selection of the delivered information is influenced by the environmental variable.

32. The method of claim 29 wherein the personal attribute is the gender of the user.

33. The method of claim 29 further comprising the step of decrypting with a decryption key the information relating to a personal attribute of an Internet user.

34. A computer program product for presenting customized information for display by a computer, the computer program product comprising:
a computer readable medium;
first instructions for accepting as input a personal attribute of a human user;
second instructions for displaying a presentation, which is customized based upon a gender of the human user,
wherein the instructions are embodied within the computer readable medium.
